(19) United States
(12) Patent Application Publication
(10) Pub. No.: US 2025/0110019 A1
(43) Pub. Date: Apr. 3, 2025

(54) METHODS AND SYSTEM FOR FLOW CONTROL TESTING

(71) Applicant: ASM IP Holding B.V., Almere (NL)

(72) Inventors: Harihara Krishnan Krishnamoorthy, Tempe, AZ (US); Gary Paulsen, Phoenix, AZ (US); Douglas Downey, Scottsdale, AZ (US); Lakshet Sehgal, Phoenix, AZ (US); Kelsey Johnson, Scottsdale, AZ (US); John Nicklos, Phoenix, AZ (US)

(21) Appl. No.: 18/895,606

(22) Filed: Sep. 25, 2024

Related U.S. Application Data
(60) Provisional application No. 63/541,645, filed on Sep. 29, 2023.

(51) Int. Cl. G01M 13/003

(52) U.S. Cl. CPC G01M 13/003

(57) ABSTRACT

Various embodiments of the present technology may provide a test fixture for testing flow of a restrictor. The test fixture may be coupled downstream from a flow control assembly. The test fixture may include a body with a threaded region and a gland coupled to the body with a threaded nut. The text fixture outlet may be vented to the atmosphere.

### CROSS-REFERENCE TO RELATED APPLICATIONS

This application is a nonprovisional of, and claims priority to and the benefit of, U.S. Provisional Patent Application No. 63/541,645, filed Sep. 29, 2023 and entitled “METHODS AND SYSTEM FOR FLOW CONTROL TESTING,” which is hereby incorporated by reference herein.

### FIELD OF INVENTION

The present disclosure generally relates to a method and system for flow control testing. More particularly, the present disclosure relates to testing the flow control of a restrictor with a test bench system.

### BACKGROUND OF THE TECHNOLOGY

Semiconductor manufacturing tools utilize restrictor gaskets in a number of locations to meter flow of a gas through the system. During maintenance, it is difficult to know which restrictor is causing flow variance, so all of them are replaced at once leading to a lot of scrap and increased expenses. Conventional methods for inspecting the restrictor include an optical-based method to measure the diameter of the orifice, however, this method is not accurate since flow variations are seen on restrictors that are labeled as having the same diameter.

### SUMMARY OF THE INVENTION

Various embodiments of the present technology may provide a test fixture for testing flow of a restrictor. The test fixture may be coupled downstream from a flow control assembly. The test fixture may include a body with a threaded region and a gland coupled to the body with a threaded nut. The text fixture outlet may be vented to the atmosphere.

According to one aspect, a system comprises: a manual shut-off valve; a regulator connected downstream from the manual shut-off valve; a filter connected downstream from the regulator; a pressure controller connected downstream from the filter; and a test fixture connected downstream from the pressure controller, wherein the test fixture is configured to secure a restrictor.

In one embodiment, the system further comprises a stand-alone power supply.

In one embodiment, the system further comprises a pressure transducer disposed between the filter and the pressure controller.

In one embodiment, the manual shut-off valve comprises an inlet configured to couple to an inert gas supply.

In one embodiment, the test fixture comprises: a body comprising a threaded region; and a gland coupled to the body with a threated nut.

In one embodiment, the body and the gland are spaced apart from each other by a gap.

In one embodiment, the test fixture further comprises a sealing element disposed between the body and the gland.

In one embodiment, the gland comprises an outlet vented to the atmosphere.

According to another aspect, a system comprises: a flow control assembly comprising an inlet; a test fixture coupled downstream from the flow control assembly, and comprising: a body comprising a threaded region; a gland coupled to the body with a threaded nut, wherein the threaded nut is configured to mate with the threaded region of the body; and an outlet vented to atmosphere; and an inert gas supply coupled to the inlet of the flow control assembly.

In one embodiment, the body further comprises a channel disposed at a surface of the body and a sealing element disposed within the channel.

In one embodiment, the test fixture further comprises a sealing element disposed between the body and the gland.

In one embodiment, the system further comprises a stand-alone power supply.

In one embodiment, the flow control assembly comprises: a manual shut-off valve; a regulator connected directly to and downstream from the manual shut-off valve; a filter connected directly to and downstream from the regulator; and a pressure controller connected directly to and downstream from the filter.

In one embodiment, the test fixture is connected directly to and downstream from the pressure controller.

In one embodiment, the test fixture is configured to hold a restrictor between the body and the gland.

In yet another aspect, a system comprises: a flow control assembly comprising: a manual shut-off valve comprising an inlet coupled to an inert gas supply; a regulator connected downstream from the manual shut-off valve; a filter connected downstream from the regulator; a pressure transducer downstream from the filter; and a pressure controller connected downstream from the pressure transducer; a test fixture coupled downstream from the flow control assembly, and comprising: a body comprising a threaded region; a gland coupled to the body with a threaded nut, wherein the threaded nut is configured to mate with the threaded region of the body; a sealing element disposed between the body and the gland; and an outlet vented to atmosphere; and a power supply electrically coupled to the pressure controller.

In one embodiment, the regulator is directly connected to the manual shut-off valve; the filter connected is directly connected to the regulator; the pressure transducer is directly connected to the filter; the pressure controller is directly connected the pressure transducer; and the test fixture is directly connected to the pressure controller.

In one embodiment, test fixture is configured to secure a restrictor between the body and the gland.

In one embodiment, the system further comprises a stand-alone power supply.

In one embodiment, the flow control assembly and the power supply are enclosed within a housing, and the test fixture is disposed outside of the housing.

### BRIEF DESCRIPTION OF THE DRAWING FIGURES

A more complete understanding of the present technology may be derived by referring to the detailed description when considered in connection with the following illustrative figures. In the following figures, like reference numbers refer to similar elements and steps throughout the figures.

FIG. 1 representatively illustrates a system in accordance with an embodiment of the present technology;

FIG. 2 is a cross sectional view of a test fixture in accordance with an embodiment of the present technology;

FIG. 3 is a perspective view of a restrictor in accordance with an embodiment of the present technology;

FIG. 4 is an exploded view of a housing used to contain the system in accordance with an embodiment of the present technology;

FIG. 5 illustrates a back view of the housing in accordance with an embodiment of the present technology;

FIG. 6 illustrates a backside of the housing in accordance with an embodiment of the present technology;

FIG. 7 illustrates an alternative test fixture in accordance with embodiments of the present technology;

FIG. 8 illustrates a cross sectional view of the embodiment of FIG. 7; and

FIG. 9 illustrates a c-seal restrictor in accordance with embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various gas lines, valves, power supply, pressure controllers, and filters.

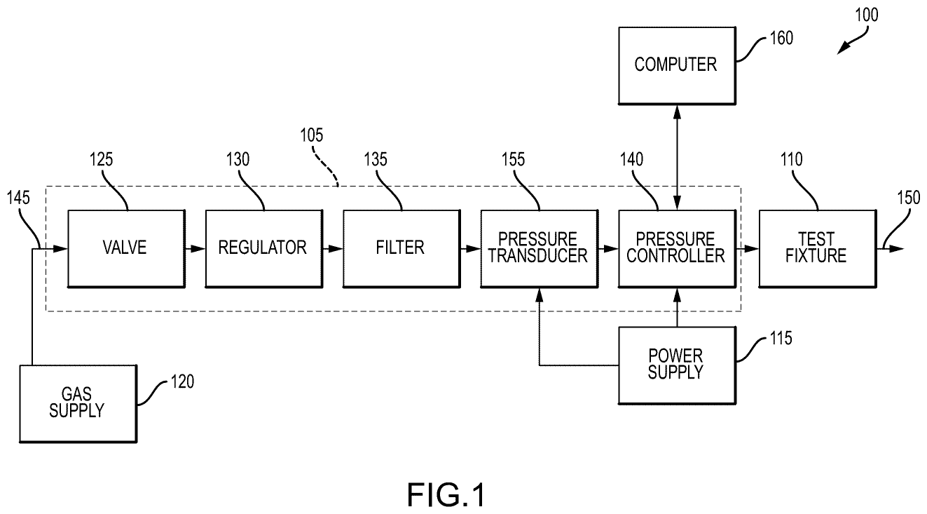

Referring to FIG. 1, an exemplary system 100 may comprise a flow control assembly 105, a test fixture 110, a power supply 115, and a gas supply 120. The flow control assembly 105 may be configured to receive a gas, control the flow of the gas, and adjust the output pressure of the gas.

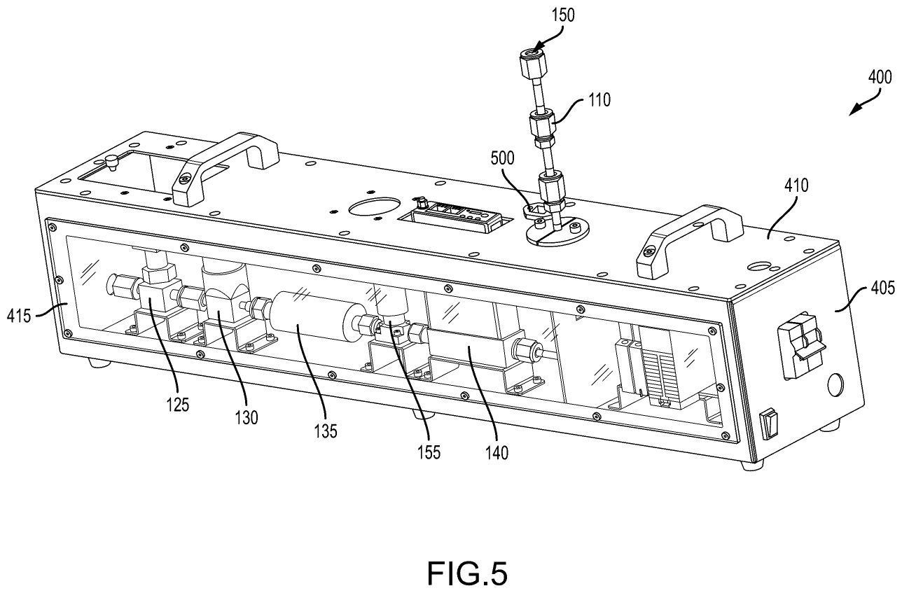

In various embodiments, the flow control assembly 105 may be configured to couple to a control device and/or a user interface, such as a laptop computer 160. For example, the flow control assembly 105 may comprise an ethernet port 500 (FIG. 5) configured to connect to the laptop computer 160. In an exemplary embodiment, the computer 160 may be configured to operate, configure, and receive information from various components in the flow control assembly 105. For example, the computer 160 may be configured to set a set point (target) pressure, control valves, and calibrate pressure variables. The computer 160 may also receive measured flow rate data and measured pressure data. The laptop controls set point (target) for pressure controller, command valve, calibrates pressure controller, The laptop receives measured flow rate and pressure from pressure controller.

In various embodiments, the flow control assembly 105 may comprise a valve 125. The valve 125 may be configured to control flow of a gas from the gas supply 120. The valve may comprise any suitable valve type, such a diaphragm valve, pneumatic valve, solenoid valve, or the like. In an exemplary embodiment, the valve 125 may comprise a manual shut-off mechanism. In other embodiments, the valve 125 may be controlled (open or closed) according to a control device that is powered by electricity. The valve 125 may further comprise an inlet coupled to the gas supply 120 and an outlet.

In various embodiments, the flow control assembly 105 may further comprise a pressure regulator 130 configured to lower the gas pressure from gas supply 120 to a desired test pressure. In an exemplary embodiment, the test pressure should be higher than 2 times the atmospheric pressure, for example, in the range of 29 psi to 40 psi. The pressure regulator 130 may be coupled to the valve 125 via a gas line. In an exemplary embodiment, an inlet of the pressure regulator 130 may be directly coupled to the outlet of the valve 125. In other words, the pressure regulator 130 may be coupled downstream from the valve 125. The pressure regulator 130 may comprise any device suitable for regulating or otherwise adjusting the pressure of a gas. The regulator 130 may further comprise an outlet.

In various embodiments, the flow control assembly 105 may further comprise a filter 135 configured to remove particles from a gas that is flowing through the filter 135. For example, the filter 135 may be selected to remove particles that may be introduced by the regulator or particles in the gas supply 120. The filter 135 may comprise any suitable gas filter and may be selected based on flow efficiency and desired level of filtration. The filter 135 may comprise an in-line filter comprising an inlet and an outlet separated by a membrane configured to filter particles from a gas flowing through the filter 135. In an exemplary embodiment, the filter 135 may be coupled downstream from and to the pressure regulator 130 via a gas line. For example, the inlet of the filter 135 may be directly connected to the outlet of the pressure regulator 130.

In various embodiments, the pressure transducer 155 may be configured to measure the output pressure of the pressure regulator 130. The pressure transducer 155 may comprise any device suitable for sensing an applied pressure and outputting an electrical signal based on the measured/sensed pressure. In an exemplary embodiment, the pressure transducer 155 may be coupled downstream from the filter 135 and the pressure regulator 130. In other embodiments, the pressure transducer 155 may be coupled downstream form the pressure regulator 130 and upstream from the filter 135.

In various embodiments, the flow control assembly 105 may further comprise a pressure controller 140 configured to regulate an outlet pressure of the flow control assembly 105. The pressure controller 140 may comprise a variable metering device to ensure a fixed outlet pressure of the pressure controller 140. In an exemplary embodiment, the pressure controller 140 may be configurable. For example, the pressure controller 140 may be set to a particular/desired set point, which provides the desired pressure at the outlet of the pressure controller 140. In various embodiments, the pressure controller 140 may be calibrated to a particular gas (i.e., a test gas in the gas supply 120).

In various embodiments, the pressure controller 140 may further comprise a flow meter that outputs pressure value and a measured flow rate value.

In various embodiments, the gas supply 120 may comprise any vessel suitable for containing an inert gas (i.e., the test gas), such as nitrogen, argon, or the like. The gas supply 120 may be coupled to the inlet 145 of flow control assembly 105, for example, inlet of the valve 125.

In various embodiments, the power supply 115 may comprise various electrical components to power various elements of the flow control assembly 105, such as the pressure controller 140 and the pressure transducer 155. For example, the power supply 115 may comprise a circuit breaker (not shown) and a power converter (not shown). The power supply 115 may be a stand-alone power supply. For example, the power supply 115 may be configured to plug into a wall outlet or may be battery powered.

In various embodiments, and referring to FIGS. 1-3, the test fixture 110 may be configured to secure a restrictor 225 and flow the gas through it without destroying or deforming the restrictor 225. For example, the test fixture 110 may comprise multiple components, with the restrictor 225 interposed between them, wherein the components of the test fixture 110 provide enough pressure on the restrictor 225 to hold it in place, but not deform or destroy it.

In an exemplary embodiment, the test fixture 110 may comprise a body 200 comprising an inlet at a first end and a male fitting, such as a threaded region, at a second end. The body 200 may comprise a first channel 235 to allow gas to flow through. In an exemplary embodiment, the inlet of the body 200 may be coupled to the pressure controller 140. The second end of the body 200 may comprise a planar surface. The planar surface may comprise a groove extending into the body 200 and arranged in a circular pattern. The groove may be sized to secure or otherwise receive a first sealing element 215, such as an o-ring. The first sealing element 215 may be formed from an elastomer, such as polytetrafluoroethylene, Kalrez®, Viton®, or the like. In various embodiments, the body 200 is formed from a metal material, such as stainless steel.

In an exemplary embodiment, the test fixture 110 may further comprise a gland 205 comprising a second channel 240. The gland 205 may comprise a first end comprising a planar surface and a second end comprising an outlet 150. The outlet 150 may be vented to atmospheric pressure, and may be connected to an exhaust vent or contained in a receptacle. The gland 205 may be formed from a metal material, such as stainless steel.

In an exemplary embodiment, the test fixture 110 may further comprise a nut 210 configured to secure the gland 205 to the body 200. For example, the nut 210 may comprise a threaded region that is sized and shaped to mate with the male fitting of the body 200. The nut 210 may further comprise various interior geometries suitable for locking with the gland 205. For example, the nut 210 may comprise a stepped region that interlocks with a stepped region on the gland 205. When the nut 210 is secured to both the body 200 and the gland 205, a gap may exist between the planar surface (i.e., the second end) of the body 200 and the planar surface (i.e., the first end) of the gland 205. The nut 210 may be formed from a metal material, such as stainless steel.

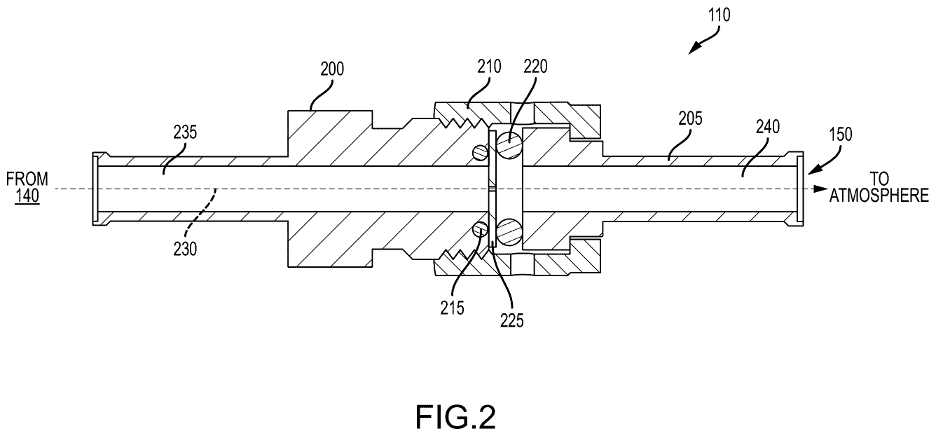

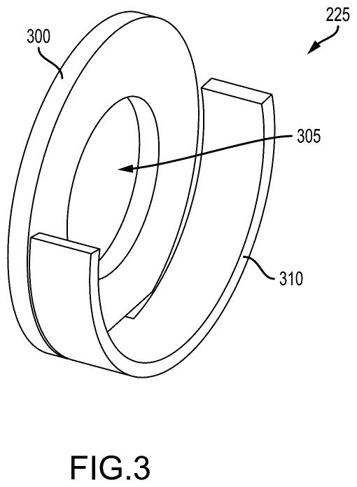

In various embodiments, and referring to FIGS. 2 and 3, the restrictor 225 may be configured to allow a gas to flow through it. For example, the restrictor 225 may comprise an orifice 305. The orifice 305 may be any size, and the size may be selected according to a desire flow rate and/or pressure. In an exemplary embodiment, the restrictor 225 may comprise a disk 300 comprising the orifice 305 and a retainer 310 coupled to the disk 300. The retainer 310 may be coupled to an outer edge of the disk 300 and form a semi-circle along the outer edge of the disk 300. The restrictor 225 may be formed from a metal material, such as stainless steel.

In an exemplary embodiment, the test fixture 110 may further comprise a second sealing element 220, such as an o-ring. The second sealing element 220 may be formed from an elastomer, such as polytetrafluoroethylene, Kalrez®, Viton®, or the like. The second sealing element 220 may be arranged adjacent to the disk 300 and along the interior edge of the retainer 310. The second sealing element 220 may abut the restrictor 225 and the gland 205.

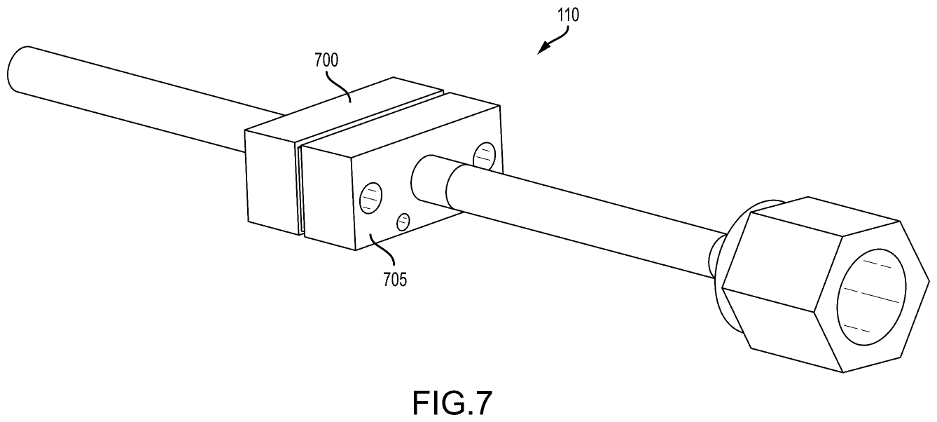

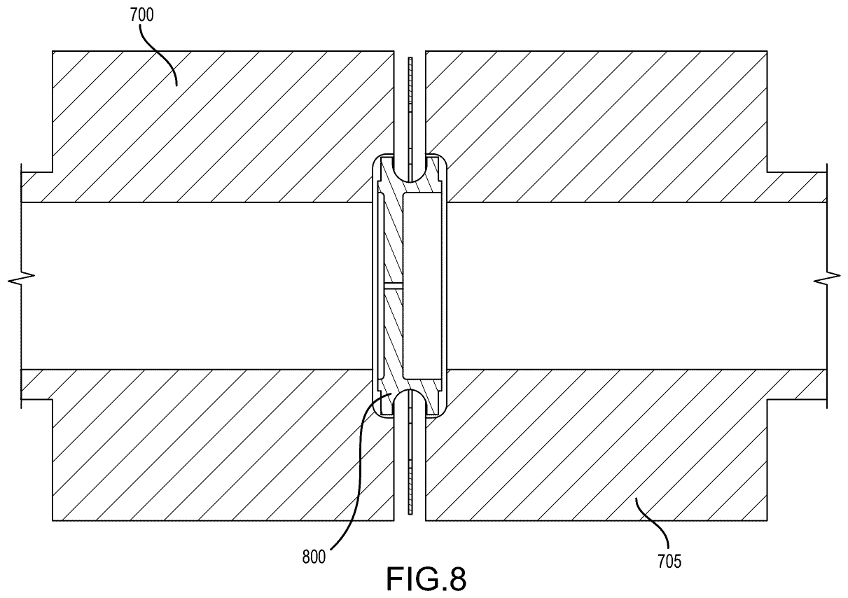

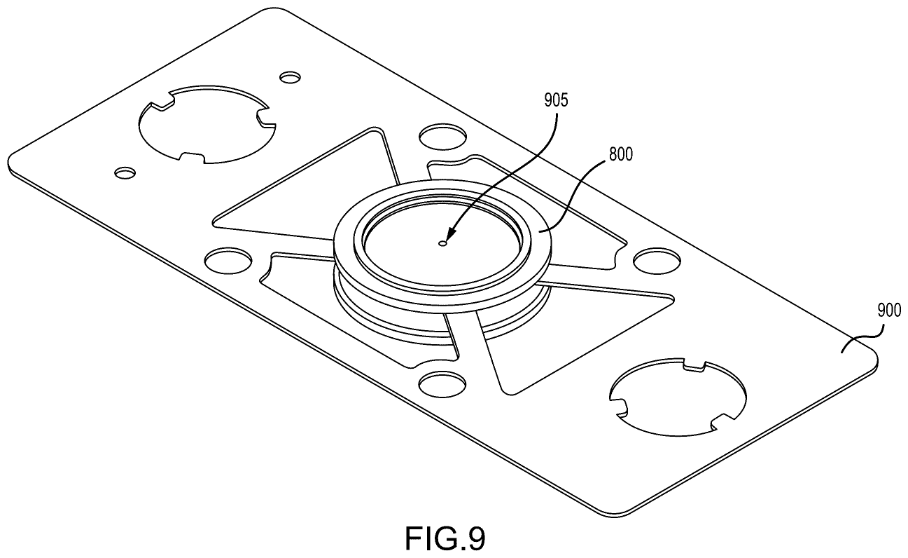

In an alternative embodiment, and referring to FIGS. 7-9, the text fixture 110 may comprise a first plate 700 and a second plate 705. The first and second plates 700, 705 may be fastened together with screws or the like. The present embodiment may be utilized to secure a c-seal restrictor 800. In particular, the c-seal restrictor 800 may be arranged between the first and second plates 700, 705, such that an orifice 905 of the c-seal 800 is aligned with the gas lines to allow gas to flow through the orifice 905. The c-seal restrictor 800 may have retainer 900 coupled to its outer edges. When the c-seal restrictor 800 is secured between the first and second plates 700, 705, the pressure and flow rate may be measured, as described below.

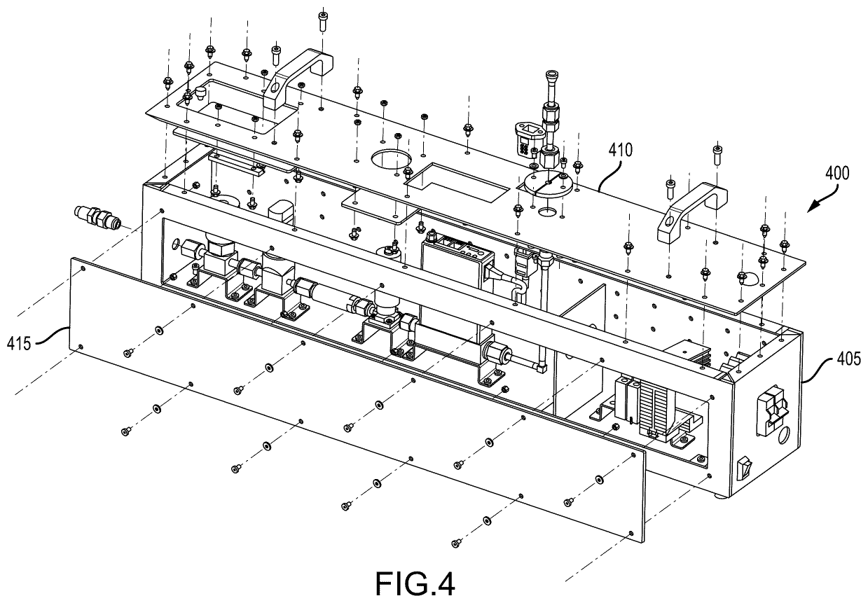

In various embodiments, and referring to FIGS. 4-6, at least a portion of the system 100 is enclosed within a housing 400. For example, the flow control assembly 105, power supply 115 may be enclosed within an interior of the housing 400. The housing 400 may comprise a frame 405, a front sidewall 415 configured to attach to the frame 405, and a top cover 410 configured to attach to the frame 405. In an exemplary embodiment, the front sidewall 415 and the top cover 410 are configured to be removable for easy accessibility into the interior of the housing 400. In some embodiments, the removable front sidewall 415 is formed from a transparent material, such as plexiglass, to provide visibility into the interior of the housing 400. The frame 405 may be formed from a metal material, such as aluminum, stainless steel, or the like. In an exemplary embodiment, the housing 400 is portable, mobile, and light weight. For example, the housing 400 with the components may weigh 30 lbs. or less. In addition, the housing 400 is sized to be compact to increase the portability and ease of maneuverability. For example, the housing 400 may have a length in the range of 60 to 100 cm, a height in the range of 10 to 20 cm, and a width in the range of 10 to 20 cm.

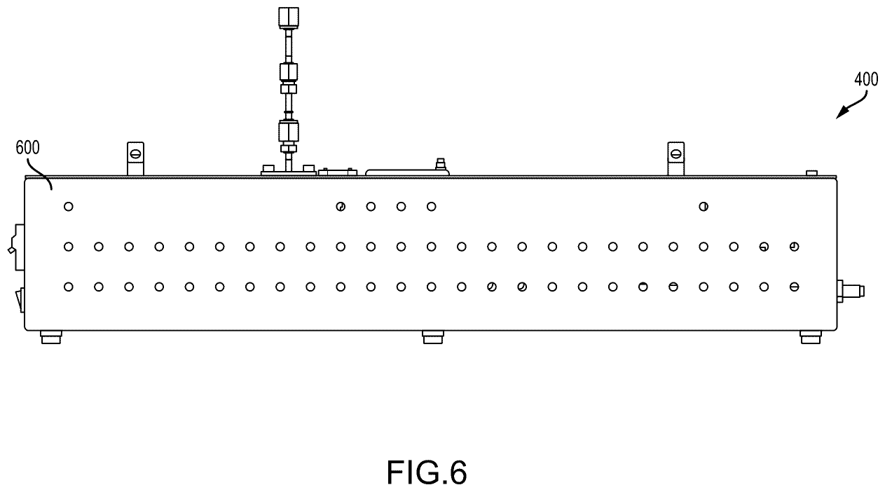

In an exemplary embodiment, the housing 400 further comprises a back sidewall 600, illustrated in FIG. 6, that is integrated within the housing 400 and not removable. The back sidewall 600 may be perforated for heat dissipation.

In operation, and referring to FIGS. 1 and 2, the computer 160 may be connected to the pressure controller 140 to set the target (i.e., desired) output pressure. The computer 160 may be also be used to calibrate the pressure controller 140 for the specific type of gas. Once the pressure controller 140 and pressure transducer 155 are powered on, the valve 125 is opened to allow gas to flow from the gas supply 120 into the flow control assembly 105. The gas flows through the valve 125, through the regulator, through the filter, through the pressure transducer, and into the pressure controller 140. The pressure controller 140 regulates the output pressure of the gas to match the set point pressure. As the gas exits the pressure controller 140, it flows into the text fixture 110. The gas flows through the first channel 235, through the restrictor 225, and out of the text fixture 110 into the atmosphere via the second channel 240. As the gas flows through the test fixture 110, the pressure controller 140 may output the actual pressure value and a measured flow rate value, which is the flow rate through the restrictor 225, to the computer 160.

In the foregoing description, the technology has been described with reference to specific exemplary embodiments. The particular implementations shown and described are illustrative of the technology and its best mode and are not intended to otherwise limit the scope of the present technology in any way. Indeed, for the sake of brevity, conventional manufacturing, connection, preparation, and other functional aspects of the method and system may not be described in detail. Furthermore, the connecting lines shown in the various figures are intended to represent exemplary functional relationships and/or steps between the various elements. Many alternative or additional functional relationships or physical connections may be present in a practical system. The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology, as expressed in the following claims.

What is claimed is:

1. A system, comprising:
a manual shut-off valve;
a regulator connected downstream from the manual shut-off valve;
a filter connected downstream from the regulator;
a pressure controller connected downstream from the filter; and
a test fixture connected downstream from the pressure controller, wherein the test fixture is configured to secure a restrictor.

2. The system according to claim 1, wherein the system further comprises a stand-alone power supply.

3. The system according to claim 1, further comprising a pressure transducer disposed between the filter and the pressure controller.

4. The system according to claim 1, wherein the manual shut-off valve comprises an inlet configured to couple to an inert gas supply.

5. The system according to claim 1, wherein the test fixture comprises:
a body comprising a threaded region; and
a gland coupled to the body with a threated nut.

6. The system according to claim 5, wherein the body and the gland are spaced apart from each other by a gap.

7. The system according to claim 5, wherein the test fixture further comprises a sealing element disposed between the body and the gland.

8. The system according to claim 5, wherein the gland comprises an outlet vented to the atmosphere.

9. A system, comprising:
a flow control assembly comprising an inlet;
a test fixture coupled downstream from the flow control assembly, and comprising:
a body comprising a threaded region;
a gland coupled to the body with a threaded nut, wherein the threaded nut is configured to mate with the threaded region of the body; and
an outlet vented to atmosphere; and
an inert gas supply coupled to the inlet of the flow control assembly.

10. The system according to claim 9, wherein the body further comprises a channel disposed at a surface of the body and a sealing element disposed within the channel.

11. The system according to claim 9, wherein the test fixture further comprises a sealing element disposed between the body and the gland.

12. The system according to claim 9, wherein the system further comprises a stand-alone power supply.

13. The system according to claim 9, wherein the flow control assembly comprises:
a manual shut-off valve;
a regulator connected directly to and downstream from the manual shut-off valve;
a filter connected directly to and downstream from the regulator; and
a pressure controller connected directly to and downstream from the filter.

14. The system according to claim 13, wherein the test fixture is connected directly to and downstream from the pressure controller.

15. The system according to claim 9, wherein test fixture is configured to hold a restrictor between the body and the gland.

16. A system, comprising:
a flow control assembly comprising:
a manual shut-off valve comprising an inlet coupled to an inert gas supply;
a regulator connected downstream from the manual shut-off valve;
a filter connected downstream from the regulator;
a pressure transducer downstream from the filter; and
a pressure controller connected downstream from the pressure transducer;
a test fixture coupled downstream from the flow control assembly, and comprising:
a body comprising a threaded region;
a gland coupled to the body with a threaded nut, wherein the threaded nut is configured to mate with the threaded region of the body;
a sealing element disposed between the body and the gland; and
an outlet vented to atmosphere; and
a power supply electrically coupled to the pressure controller.

17. The system according to claim 16, wherein:
the regulator is directly connected to the manual shut-off valve;
the filter connected is directly connected to the regulator;
the pressure transducer is directly connected to the filter;
the pressure controller is directly connected the pressure transducer; and
the test fixture is directly connected to the pressure controller.

18. The system according to claim 16, wherein the test fixture is configured to secure a restrictor between the body and the gland.

19. The system according to claim 16, wherein the system further comprises a stand-alone power supply.

20. The system according to claim 19, wherein the flow control assembly and the power supply are enclosed within a housing, and the test fixture is disposed outside of the housing.
